(19) United States
(12) Patent Application Publication
(10) Pub. No.: US 2010/0265131 A1
(43) Pub. Date: Oct. 21, 2010

(54) PORTABLE DEVICE TRACKING SYSTEM

(76) Inventor: CHARLES FABIUS, Princeton Junction, NJ (US)

Correspondence Address: Thien Tran/ Access Patent Group, LLC, 7706 Tanner Robert Court, Springfield, VA, 22153, US

(21) Appl. No.: 12/762,296

(22) Filed: Apr. 16, 2010

Related U.S. Application Data
(60) Provisional application No. 61/169,755, filed on Apr. 16, 2009.

(51) Int. Cl. G01S 19/16; G01S 19/24

(52) U.S. Cl. 342/357.54; 342/357.63

(57) ABSTRACT

A device tracking system for tracking location coordinates of a portable device in real time is provided. The system includes a microprocessor chip in which a GPS transceiver is embedded. The microprocessor chip is installed in the portable device. The system also includes at least one GPS satellite capable of communicating with the GPS transceiver for obtaining location coordinates of the portable device, at least a second GPS transceiver coupled with the GPS satellite via a satellite antenna for receiving the obtained location coordinates; and a computer server coupled with the second GPS transceiver for communicating the obtained location coordinates to an authorized user via a web-enabled program.

### CROSS-REFERENCE TO RELATED APPLICATION

This application claims the benefit of Provisional Patent Application No. 61169755 filed on Apr. 16, 2009, in the United States Patent & Trademark Office, the disclosure of which is incorporated herein by reference.

### FIELD OF INVENTION

The present invention is directed towards device retrieval. More particularly, the present invention provides a system for tracking on lost or stolen portable devices by using Global Positioning System (GPS) satellites.

### BACKGROUND OF THE INVENTION

Tracking technologies available for locating lost or stolen portable devices in the present times are quite limited in their scope. Currently, the most commonly available tracking service is limited to locating cellular/mobile phones. However, such tracking service only operates while the cellular phone is switched on; once the battery of the phone runs out or it is manually turned off, its location can no longer be determined. When other valuable portable devices such as MP3 players, laptops, and game consoles are misplaced or stolen, there is no effective way to locate and retrieve them, since these devices do not contain any tracking equipment.

In the recent times, tracking systems employing the global positioning system (GPS) are being increasingly used. The GPS is a network of radiolocation and radionavigation apparatus that operates on a worldwide basis. The GPS system employs at least three satellites and allows determination of latitude, longitude, and altitude with triangulation technique.

U.S. Pat. No. 6,847,892 discloses a system for localizing and sensing objects and providing alerts to users. The system comprises a remote device that includes a sensor for determining or measuring a desired parameter, a receiver for receiving position data from a Global Positioning System (GPS) satellite system, a processor for determining whether or not alert conditions are present and a wireless transceiver for transmitting the measured parameter data and the position data to a central station, such as an application service provider (ASP). The ASP, in turn, may communicate the measured data, position data and notification of any alerts to an end user via an alert device.

United States Patent Application No. 20090055265 discloses a computer implemented lost key rewards system and method which comprises of a central electronic database providing for the confidential registration of a key owner's contact and key information to facilitate the return of a lost key, while providing for a rewards program for a key tag finder. Once reported as lost and/or stolen, if the key tag has an embedded locator tracking device, the disclosed system may use GPS technology to activate the tracking device to locate the lost key tag.

United States patent application 20100019895A1 describes a system and method for locating and tracking stationary or moving personal property. The described system comprises a concealed article unit attached to the article to be tracked and a portable owner unit, which is programmed into the cellular phone of the user or owner. This invention is also known by its trademark name of “EZTrak”, and is based on the principle of firstly attaching a tracking integrated circuit chip to the article to be tracked; and secondly carrying an owner unit in wireless communication with said tracking integrated circuit chip.

Another U.S. Pat. No. 7,379,729 describes a locator system comprising an e911-enabled wireless network including a switching center which is configured to receive a request to generate location information regarding a remote mobile station, and send said location information to a subscriber only after obtaining consent from the remote mobile station.

U.S. Pat. No. 7,375,654 discloses a method of asset location. The method comprises receiving location data from a cellular transmitter associated with a selected asset and communicating it to a tracking service system, which includes a database of geographic locations associated with a plurality of cellular receivers. The database is then queried with received location data so as to generate geographic tracking data associated with a location of the cellular receiver. The geographic tracking data is then communicated to an associated security agency for viewing of an image generated in accordance with the display data and at least one of tracking and interception of the selected asset.

United States Patent Application No. 20080129491 discloses a locator and tracking system (LTS) in which a number of devices provide location and status information through one or more communication networks to a server system that hosts a website and a location and tracking application, which is accessible by and downloadable to one or more client computers. The website feeds information to the location and tracking application for display to users of the client computers.

US Patent Application No. 20090119119 discloses a tracking and monitoring system which consist of a tracking device which is an integrated circuit chip used for tracking individuals or objects and a web-based application where a user accesses and tracks object with the tracking device attached.

United States Patent Application No. 20050186938 provides a system for the locating and/or tracking of specific portable radio frequency transmitters uniquely associated with a single person. In cases of kidnapping or runaway where people go missing, the tracking systems currently available to locate these individuals are based on a monthly recurring fee and utilize tracking devices designed for use specifically for that purpose. The systems includes the radio transmitters, which consist of a portable radio frequency transmitter embodied as a small pen-shaped unit which can be carried on a keychain or in the user's pocket or purse or an implantable device which can conveniently be implanted subdermally, a network of receiving stations for the reception of radio frequency signals transmitted by the portable units, and a central monitoring station for providing information regarding the person associated with a particular radio frequency transmitter.

U.S. Pat. No. 5,731,757 discloses a portable locator or tracking apparatus for continuous location determination of subjects which communicates with a body-worn, non-removable, tamper resistant transceiver and a central data-base system. The portable tracking apparatus has a Global Position System (GPS) receiver and inertial sensors for determining location, microprocessors for logic and mathematical algorithm processing, memory for programs and data, a wireless transceiver for communications with the body-worn device, a wireless transceiver for communicating with the central database system, an alpha-numeric display for displaying text messages sent to the subject acoustic speaker and microphone for voice and tone messages with subjects, electronic tamper sensors, motion sensors, attitude position sensor, batteries and external connectors for power, recharge, communications and auxiliary antennas.

United States Patent Application No. 2004021573 discloses a security and signaling system, submitting an audible signal to a person in state of emergency, combined with a locating system, as to alert and instruct the person appropriately according to his necessities and localize the same.

Also, United States Patent Application No. 20090027193 discloses a tracking system of human beings, animals or objects. The system comprises transceiving micro-devices located within the body to be tracked, information collecting network for collecting data transmitted by the transceiver devices, portable or mobile devices for immediate personal identification, sub-centers for simultaneous and immediate availability of data and a storing center for all data picked up and transmitted by the collecting network.

United States Patent Application No. 20070229350 discloses a system for monitoring objects and individuals. The system includes a first tracking device and a monitoring station to track location information. A user interface provides to remotely access the monitoring station.

Most of the tracking systems and methods available require purchasing specialized equipment or paying monthly recurring costs such as insurance costs. For example, people pay monthly insurance for cell phones. In addition, if the phone is lost, and the insurance company compensates for its loss, all of the user's personal information stored in the phone's database is lost. Some cell carriers offer the option of storing the phone's information in a web server. However, if the web server is hacked, then all the information is stolen. Further, most of the available tracking systems operate on power derived from the battery or power supply of the device being tracked. However, if the device looses power or is turned off the tracking devices also fail.

Accordingly, there is a need for a tracking and locating system and method which provides for a small sized device, which can be easily fit into any portable device which is of value and requires to be tracked. Further, there is need for a tracking system which is hardware based and is independent of the power supply of the device being tracked. Also, is required a tracking system which is affordable, easy to use and uses existing positioning technology such as GPS. Hence, there is need for a device tracking system that eliminates the need to pay for theft insurance on many portable devices and also allows items to be returned with personal data intact. The present invention satisfies these needs, as well as others, and generally overcomes the deficiencies found in the background art.

### SUMMARY OF THE INVENTION

The present invention is directed towards device retrieval and provides a system for tracking lost or stolen portable devices by using Global Positioning System (GPS) satellites. The device tracking system comprises a GPS transceiver in the form of a microchip that can be implanted into all portable devices during the manufacturing stage. The transceiver may independently run on or self-powers on a lithium battery power contained therein, and is thin enough to fit inside small devices, such as mobile phones, MP3 players, laptop, . . . etc. . . .

In various embodiments of the present invention, a device tracking system for tracking location coordinates of a lost or stolen portable device in real time is provided. The system comprises a microprocessor chip which is impregnated with a GPS transceiver and the microprocessor chip is embedded in the portable device being tracked. The system further comprises at least three GPS satellites capable of communicating with the GPS transceiver for obtaining location coordinates of the portable device, at least a second GPS receiver coupled with the GPS satellite via a satellite antenna for receiving the obtained location coordinates; and a computer server (with databases) coupled with the second GPS receiver for communicating the obtained location coordinates to an authorized user via a web-enabled program.

Also, in various embodiments, the dimensions of the microprocessor chip are small enough to enable the same to be embedded in a plurality of portable devices and the microprocessor chip comprises a lithium battery for powering the GPS transceiver. In other embodiments, other commonly available types of batteries may also be used to power the GPS receiver. The battery ensures that the GPS transceiver remains functional even when the portable device is switched off (e.g. the GPS transceiver is self-powered). This enable tracking of the lost or stolen portable device after its own power has been consumed or it has been manually shut down.

In an embodiment, the microprocessor chip is embedded in the portable device during a manufacturing stage of the portable device. In another embodiment, the microprocessor chip is embedded in the portable device at any time (e.g. at retail store, telephone dealer, at home . . . ) by placing the microprocessor chip within a battery compartment of the portable device. The microchip can be sold in a kit with instruction manual for service subscription.

The microprocessor chip is fastened by a fastening means 105B such as clips, or Velcro or peel-off glue on the back of the chip into the portable device or sewn to the clothing of the child or fastened to the collar of dog, cat, pet or animal or attached to a hidden place of the vehicle, truck, automobile, boat.

In various embodiments, the authorized user or owner possesses a unique serial number (USN) corresponding to the portable device being tracked, the unique serial number (USN) being provided to the user upon registration of the portable device with a service provider having the computer server and databases. The service provider can be a retail store or an online tracking service provider

In another embodiment, the authorized user communicates with the computer server by using a computing device and the Internet; whereas in an alternate embodiment, the authorized user communicates with the computer server by using a telephone and a telephone network. The telephone network may also be a cellular network or non-cellular landline network. Also, in various embodiments, the device tracking system provides device tracking services to a plurality of authorized users during the lifetime of the portable device upon receipt of a predefined fee. Further, in an embodiment, the device tracking system supports one of: assisted GPS technology (A-GPS) and enhanced GPS (E-GPS) technology for tracking devices located at places, such as tunnels and basements, which are not in direct line of sight of the GPS satellite.

### BRIEF DESCRIPTION OF THE ACCOMPANYING DRAWINGS

The present invention is described by way of embodiments illustrated in the accompanying drawings wherein:

FIG. 1 is a block diagram illustrating the device tracking system, in accordance with an embodiment of the present invention;

FIG. 2A illustrates a microchip comprising a GPS transceiver, in accordance with an embodiment of the present invention;

FIG. 2B illustrates portable devices which can be tracked by using the microchip illustrated in FIG. 2A;

FIG. 2C illustrates the chip's components;

FIG. 3 illustrates the steps of registration by the owner; and

FIG. 4 illustrates the GPS coordinates of lost device are displayed or overlayed with a map.

### DETAILED DESCRIPTION OF THE INVENTION

A system for tracking portable devices is described herein. The present invention provides a microprocessor chip comprising a GPS transceiver capable of communicating its location coordinates to a GPS satellite tracking system. The microprocessor chip's size is small enough to fit into any portable device of value to a user or owner such as mobile phones, laptop computers, personal digital assistants (PDA), digital cameras, DVD players, etc. The microprocessor chip is installed during the manufacturing stage of a portable device and a user is provided with an option to register the device with an authorized tracking website. After registration the user is enabled to track the device location in real time or near real-time through the website by entering the device registration number.

The following disclosure is provided in order to enable a person having ordinary skill in the art to practice the invention. Exemplary embodiments are provided only for illustrative purposes and various modifications will be readily apparent to persons skilled in the art. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

The present invention would now be discussed in context of embodiments as illustrated in the accompanying drawings.

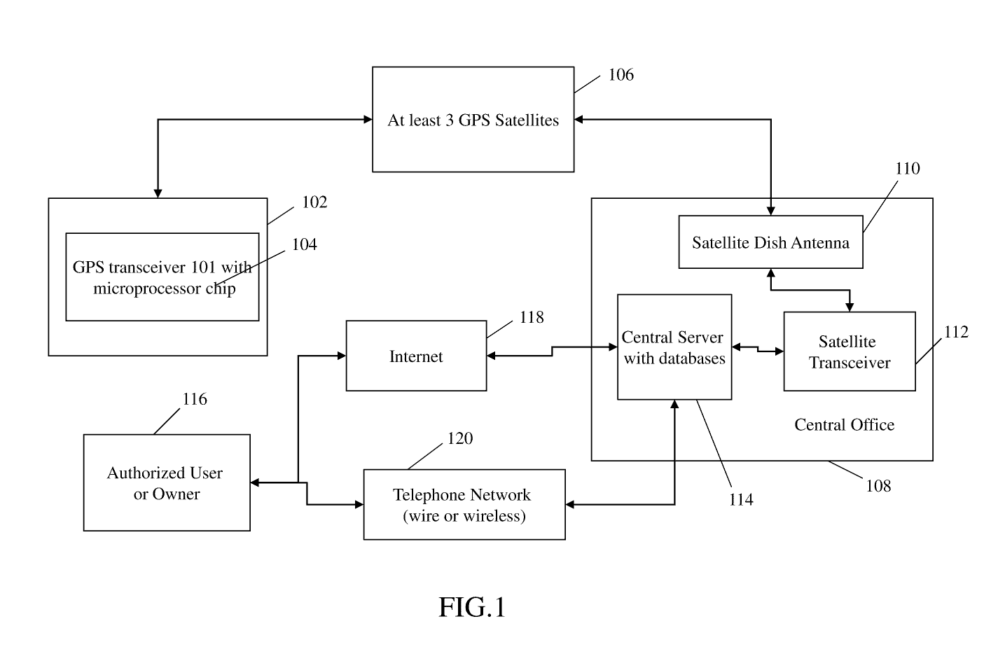

FIG. 1 is a block diagram illustrating the device tracking system, in accordance with an embodiment of the present invention. The system comprises a microprocessor chip 104 embedded in a portable device 102, a GPS satellite 106, a central office 108 comprising a satellite dish antenna 110, a satellite transceiver 112 and a central server 114. A user 116 may access the central server 114 via the Internet 118 or a telephone network 120.

The microprocessor chip 104 comprises a microprocessor 101D, memory 101C, an antenna, a GPS satellite transceiver 101 embedded therein for receiving signals from the GPS satellite 106 and a signal generating circuit 101A for communicating back its location in response. In an embodiment, the microprocessor chip 104 is provided with an insulated covering 105A making the chip 104 water proof. Further, the dimensions of the microprocessor chip 104 are small enough to fit inside any portable device 102. In an embodiment, the microprocessor chip 104 is designed to fit in or on a key chain or an article of clothing. The GPS technology being used in conjunction with the GPS satellite transceiver embedded in the chip 104 uses the standard frequencies being commonly deployed in known GPS location and retrieval based technology. Commercially available GPS transceivers often provide a 1 pulse per second (pps) timing output, and standard frequencies such as 1, 5, and 10 MHz.

In an embodiment, each microprocessor chip 104 possesses a unique identification (a unique serial number (USN)) code which is recorded at the central server 114 when a user registers the portable device 102 comprising the microprocessor chip 104 with the central server 114. In an embodiment, the microprocessor chip 102 is installed in the portable device 102 at the manufacturing stage of the device 102. In another embodiment, the microprocessor chip 104 may be used in conjunction with existing portable devices by installing the chip 104 in the battery compartment of the devices. In various embodiments, the GPS satellite transceiver in the microprocessor chip 104 is powered by a lithium battery 101B coupled to it and contained within the microprocessor chip 104, thereby ensuring that the transceiver continues to function even if the device 102 is switched off.

In an embodiment of the present invention, the microprocessor chip 104 is designed to continuously emit a predefined signal which can be picked up by any GPS based satellite within a predefined distance of the microprocessor chip 104. In various embodiments, the satellite dish 110 and the satellite transceiver 112 may be standard devices commonly known in the art for providing the function of communicating with GPS satellite 106. In an embodiment, the satellite dish 110, the satellite transceiver 112 as well as the microprocessor chip 104 support enhanced GPS (e-GPS) technology. The enhanced GPS technologies allow signals emanating from the microprocessor chip 104 to be detected even when the device 102 carrying the chip 104 is located in tunnels, homes, underground areas, and other spaces where a direct line of sight is not possible. Hence, with use of enhanced GPS technologies the signals from the device 102 can be picked up from any GPS satellite's orbit.

In an embodiment of the present invention, the device tracking system is offered as a lifetime service for a one time payment to users. Once a user purchases the service corresponding to a particular portable device 102, a unique serial number (a unique serial number (USN)) is provided to the authorized user. The authorized user may enter the serial number in a web-based application hosted by the central server 114 by using the Internet 118 for obtaining the location of the device. The device 102 communicates its location coordinates with the GPS satellite 106 via the embedded GPS satellite transceiver in the microprocessor chip 104. The GPS satellite 106 in turn communicates the same to the central server 114 via the satellite dish 110 and the satellite transceiver 112. Hence, by signing up for the device tracking service, the authorized user or owner is enabled to track the device 102 in real time by accessing the web program hosted by the central server 114.

In an embodiment, an authorized user or owner may communicate with the central server 114 by using a telephone network 120 (e.g. wire or wireless, cellular phone system . . . ). The user may dial a predefined number to access the central server 114. The authorized user's call may be intercepted by a human operator or an integrated Voice Response (IVR) system which would communicate the device's location to the user upon obtaining the unique serial number (a unique serial number (USN)) from the user. In an embodiment, where the user suspects that the device 102 has been stolen, a recovery team may be sent out for retrieval and/or law enforcement authorities may be informed or notified. In various embodiments, the authorized users may be provided with a certificate showing that they purchased the service and also the certificate may be transferred to another user if desired.

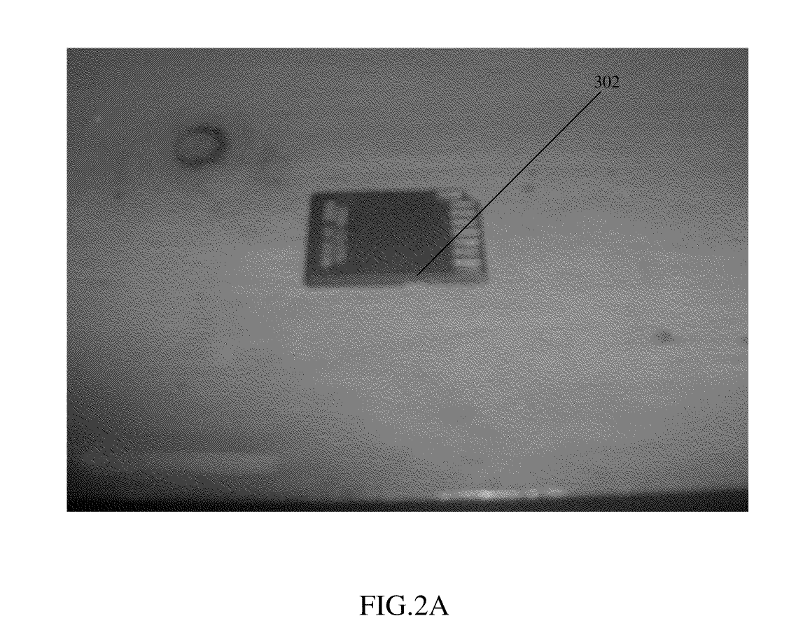

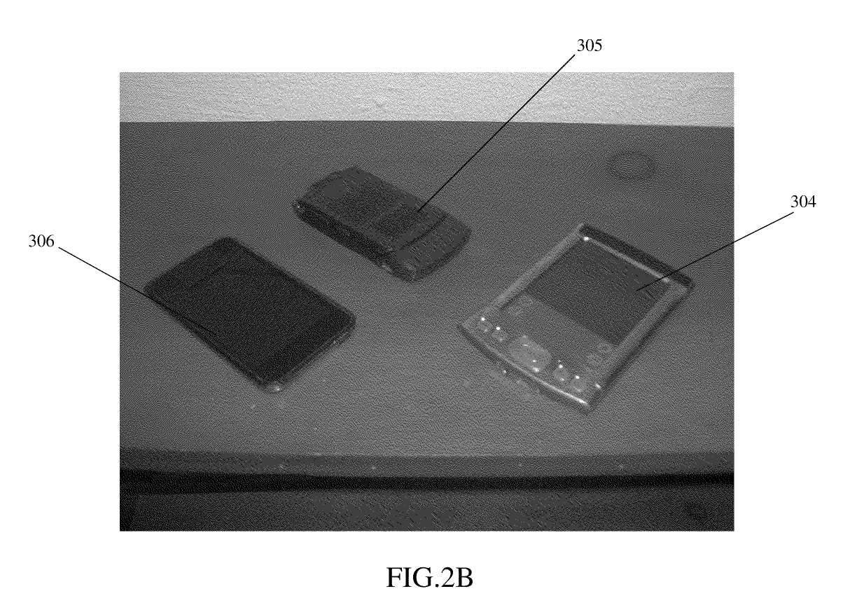

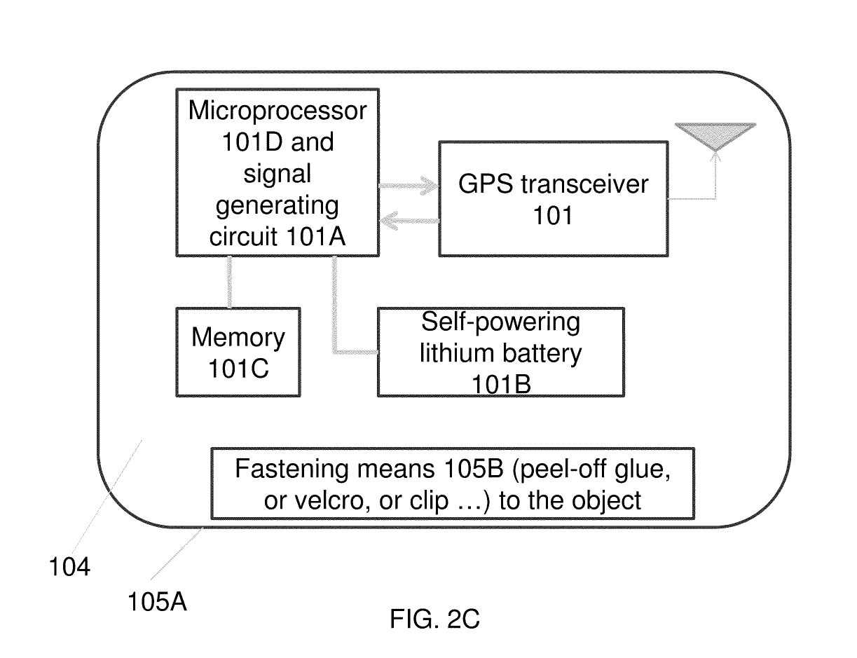

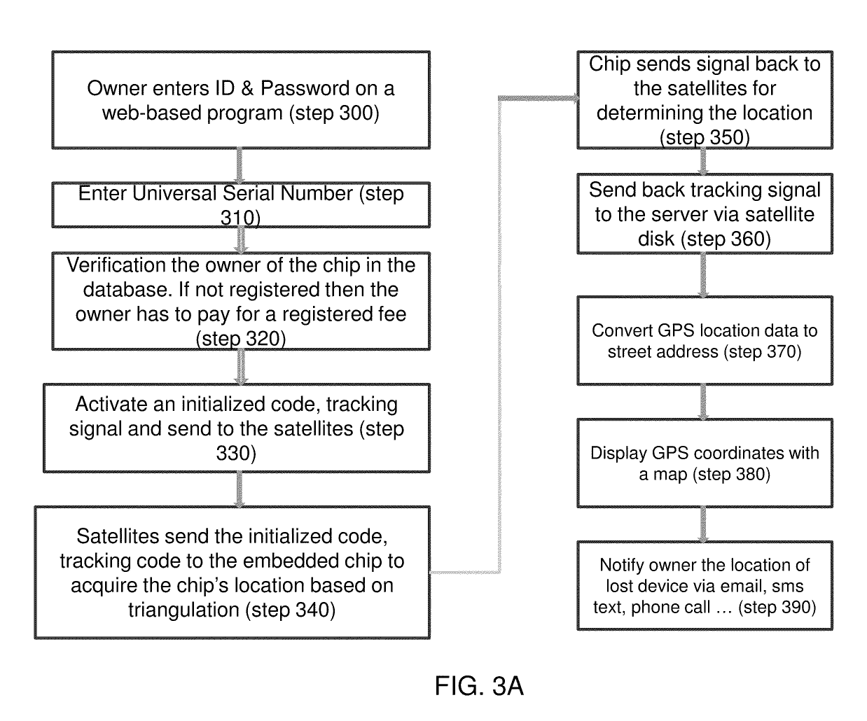

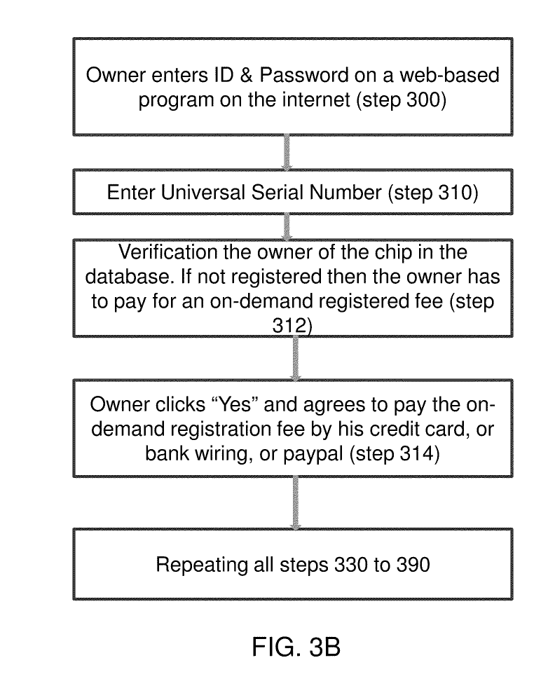

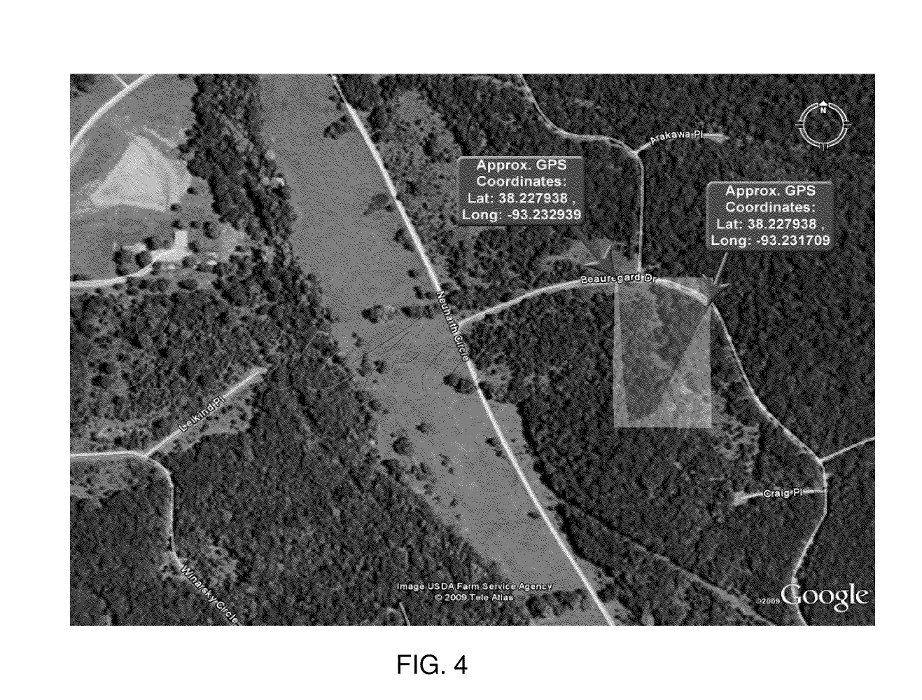

FIG. 2A illustrates a microchip 302 (or chip 104) comprising a GPS transceiver 101, in accordance with an embodiment of the present invention. FIG. 2B illustrates portable devices which can be tracked by using the microchip illustrated in FIG. 2A. Examples of portable devices that can be tracked using the present invention include a Personal Digital Assistant PDA (Palm Pilot) 304, a cellular phone 305, a personal music player 306, laptop, clothing . . . etc. . . . The microchip 302 comprises a GPS transceiver 101 as well as a lithium battery 101B for powering the GPS transceiver itself in addition to standard electronic circuitry commonly known in the art. In an embodiment, the microchip 302 may be embedded in the Personal Digital Assistant PDA (Palm Pilot) 304 at the time of manufacture. In another embodiment, the microchip 302 may be installed in the battery compartment of the personal music player 306 at any time for tracking the device.

Scenario 1: User has already registered their portable device with the tracking system: In a typical installation, the central office (108) will have a central server including web server, an application server, and a database. The web server would serve as the portal or gateway into the web application from the internet. The user would be prompted for a user id and password (step 300). Once user id and password are entered, the user would be prompted to enter the unique/universal serial number (USN) (step 310) which represents the registration information of the portable device being tracked. The USN would be hard coded into the microchip/transceiver which is mounted into the portable device. Once the USN is entered, the portable device with the microchip would be searched in the database linked with the application server. The owner is then verified (step 320). Once retrieved in the database, the application server would then send a tracking signal and initialized code to the device via the GPS satellites (at least 3 satellites so that device location can be triangulated) (steps 330 & 340). The microchip/transceiver would respond to the initialized code and tracking signal, at which time the application server would be able to retrieve and determine the location information (step 350) and forward the information or send back tracking signal (step 360) back to the server of the central office (via a satellite disk). The GPS location data is converted to the approximate street address (step 370). Then, the GPS coordinates is displayed along with the street addresses of a map (step 380). The owner is notified the location of lost device (item) via email, sms text, phone call (step 390).

Scenario 2: User has not registered their portable device with the tracking system: If the user has not pre-registered their device with the tracking system at time of purchase, since the device already has the microchip/transceiver already mounted inside, then they can register online and activate the microchip/transceiver on demand. In this case, the user would register with the web server by creating their own user id and password (step 300). Once entered, the user would be prompted for the unique/universal serial number (USN) (step 310). Once this information is entered, the user would get a message indicating the USN is not registered but can be for a fee (step 312). The user will also be asked if they would like to register the USN of the microchip/transceiver with the application server's database. If the user replies or clicks “yes”, then the user will be taken to a page where they can enter their USN and credit card information (or bank wiring information, paypal, . . . ) (step 314). Once entered and the transaction completes, the user's microchip/transceiver is then registered and the user will be prompted to return to the page where the USN can be entered within the database search. Once the USN is entered and the database determines that the USN is in fact registered, the GPS location service will take place and the location information will be retrieved and forwarded to the user while logged on. Basically, all of the steps 330-390 are then repeated. Once retrieved in the database, the application server would then send a tracking signal and initialized code to the device via the GPS satellites (at least 3 satellites are used so that device location can be triangulated) (steps 330 & 340). The microchip/transceiver would respond to the initialized code and tracking signal, at which time the application server would be able to retrieve and determine the location information (step 350) and forward the information or send back tracking signal (step 360) back to the server of the central office (via a satellite disk). The GPS location data is converted to the approximate street address (step 370). Then, the GPS coordinates is displayed along with the street addresses of a map (step 380). The owner is notified the location of lost device (item) via email, sms text, phone call (step 390).

Therefore the present invention provides a satellite-tracking system that provides consumers with a method of retrieving lost or stolen property. The device tracking system of the present invention may be used for tracking any device that is portable and has some kind of value to a user such that the user would have an interest in retrieving the device if lost or stolen. The system of the present invention is ideal for use with portable devices such as mobile phones, PDA's, digital cameras, laptop computers, video games, DVD players, etc. However, the system maybe employed to track larger devices such as truck, vehicle, cars, etc and also for tracking living beings such as missing pets or even children. The users of the device tracking system can track their lost or stolen property in real time using the system. Hence, the present invention eliminates the need to pay for theft insurance on many portable devices and also allows devices to be returned with personal data intact. Therefore, the device tracking system of the present invention enables the return of valuable property to the rightful owners quickly and efficiently.

While the exemplary embodiments of the present invention are described and illustrated herein, it will be appreciated that they are merely illustrative. It will be understood by those skilled in the art that various changes in form and detail may be made therein without departing from or offending the spirit and scope of the invention as defined by the appended claims.

What is claimed is:

1. A device tracking system for tracking location coordinates of a portable device or an object in real time, the system comprising;
a microprocessor chip comprising a GPS transceiver, the microprocessor chip being embedded in the portable device;
at least one GPS satellite capable of communicating with the GPS transceiver for obtaining GPS location coordinates of the chip of the portable device;
at least a second GPS transceiver coupled with the GPS satellite via a satellite antenna for receiving the obtained GPS location coordinates; and
a computer server coupled with the second GPS transceiver for communicating the obtained GPS location coordinates to an owner via a web-enabled program in the internet hosting by the computer server at a central office.
a database for recording a unique serial number corresponding to each microprocessor chip, the database being coupled to the computer server, and
the microprocessor chip includes a separate lithium battery for self-powering the GPS transceiver.

2. The device tracking system as claimed in claim 1 wherein, the dimensions of the microprocessor chip enables the same to be embedded in a plurality of portable devices.

3. The device tracking system as claimed in claim 1, wherein the portable device or the object is selected from a group consisting of mobile phones, PDA's, digital cameras, laptop computers, video games, DVD players, truck, vehicle, cars, missing pets and children.

4. The device tracking system as claimed in claim 1 wherein, the microprocessor chip is embedded in the portable device during a manufacturing stage of the portable device.

5. The device tracking system as claimed in claim 1 wherein, the microprocessor chip is embedded in the portable device by manually placing the microprocessor chip within a battery compartment of the portable device at the time of purchase.

6. The device tracking system as claimed in claim 1, wherein, the owner possesses a unique serial number corresponding to the portable device being tracked, the unique serial number being provided to the user upon registration of the portable device with the computer server.

7. The device tracking system as claimed in claim 7 wherein, the authorized owner is prompted to provide an identification information and the unique serial number for obtaining location coordinates of the portable device, the unique serial number being sent with a tracking signal by the computer server to at least three GPS satellites for retrieving the GPS location coordinates of the portable device.

8. The device tracking system as claimed in claim 7, wherein, the portable device is registered with the computer server at the time of purchase of the portable device upon payment of a predefined fee via credit card, bank wiring or paypal.

9. The device tracking system as claimed in claim 1 wherein, the owner possesses a unique serial number corresponding to the portable device being tracked, the unique serial number being provided to the user upon purchase of the portable device; the portable device being registerable with the computer server at any time after purchase of the portable device by entering the unique serial number at a predefined website and providing a predefined fee via credit card, bank wiring or paypal; the predefined website being coupled with a web server and a database comprising the unique serial numbers corresponding to each microprocessor chip, the web server being coupled with the computer server.

10. The device tracking system as claimed in claim 1 wherein, the owner communicates with the computer server by using a computing device, a web server and the Internet.

11. The device tracking system as claimed in claim 1, wherein the GPS location coordinates are converted to an approximated street address and being displayed on a map.

12. The device tracking system as claimed in claim 11 wherein, the owner communicates with the computer server by using a telephone network and being notified the location of lost portable device via email, sms text, or phone call.

13. The device tracking system as claimed in claim 1 providing device tracking services to a different owner during the lifetime of the portable device upon receipt of a predefined fee.

14. The device tracking system as claimed in claim 1 supporting one of: assisted GPS technology (A-GPS) and enhanced GPS (E-GPS) technology for tracking portable devices located at places which are not in direct line of sight of the GPS satellite.

15. The device tracking system as claimed in claim 1, wherein the microprocessor chip is covered with a waterproof layer.

16. The device tracking system as claimed in claim 1, where the microprocessor chip is sold in a kit with instruction manual for tracking service subscription.
